(19) United States
(12) Patent Application Publication
(10) Pub. No.: US 2025/0315472 A1
(43) Pub. Date: Oct. 9, 2025

(54) IMAGE SEARCH METHOD, INTELLIGENT AGENT, ELECTRONIC DEVICE, AND STORAGE MEDIUM

(71) Applicant: Beijing Baidu Netcom Science Technology Co., Ltd., Beijing (CN)

(72) Inventors: Pengfei LUO, Beijing (CN); Jingbo ZHOU, Beijing (CN); Yuan XIA, Beijing (CN); Tong XU, Beijing (CN)

(21) Appl. No.: 19/244,373

(22) Filed: Jun. 20, 2025

(30) Foreign Application Priority Data
Dec. 3, 2024 (CN) 202411764535.6

(51) Int. Cl. G06F 16/53; G06F 40/20; G06F 40/30; G06F 40/40; G06V 10/74

(52) U.S. Cl. CPC G06F 16/53; G06F 40/20; G06F 40/30; G06F 40/40; G06V 10/761

(57) ABSTRACT

An image search method and an intelligent agent are provided, which relate to a field of artificial intelligence technology. The method includes: determining a multimodal search information according to an input information for image search, where the input information includes a first text information and/or a first reference image, and the search information includes a second text information and a second reference image; performing, by using a text analysis large model, a text analysis on the second text information and a first description information describing the second reference image to generate at least one second description information; and determining at least one target image according to the at least one second description information, where each of the at least one target image is determined according to the at least one second description information.

### CROSS-REFERENCE TO RELATED APPLICATIONS

This application is claims priority to Chinese Application No. 202411764535.6 filed on Dec. 3, 2024, which is incorporated herein by reference in its entirety.

### TECHNICAL FIELD

The present disclosure relates to a field of artificial intelligence technology, in particular to fields of computer vision, deep learning, large model, image search and other technologies, and may be applied to scenarios such as AIGC (Artificial Intelligence Generated Content). Specifically, the present disclosure relates to an image search method, an intelligent agent, an electronic device, and a storage medium.

### BACKGROUND

With a continuous development of artificial intelligence technology, large model technology has been applied in various fields. For example, it is possible to perform an image search using large models.

However, at present, when performing image search based on large models, an image search with multimodal inputs corresponds to multiple processing methods, resulting in high system complexity and high maintenance costs. In addition, it is difficult to perform an image search in complex scenarios, such as flexibly switching between multimodal inputs for image search.

### SUMMARY

The present disclosure provides an image search method and apparatus, an intelligent agent, an electronic device, and a storage medium.

According to an aspect of the present disclosure, an image search method is provided, including: determining a multimodal search information according to an input information for image search, where the input information includes a first text information and/or a first reference image, and the search information includes a second text information and a second reference image; performing, by using a text analysis large model, a text analysis on the second text information and a first description information describing the second reference image to generate at least one second description information; and determining at least one target image according to the at least one second description information, where each of the at least one target image is determined according to the at least one second description information.

According to another aspect of the present disclosure, an image search apparatus is provided, including: a first determination module configured to determine a multimodal search information according to an input information for image search, where the input information includes a first text information and/or a first reference image, and the search information includes a second text information and a second reference image; a generation module configured to perform, by using a text analysis large model, a text analysis on the second text information and a first description information describing the second reference image to generate at least one second description information; and a second determination module configured to determine at least one target image according to the at least one second description information, where each of the at least one target image is determined according to the at least one second description information.

According to another aspect of the present disclosure, an intelligent agent of artificial intelligence is provided, configured to perform the method provided in embodiments of the present disclosure.

According to another aspect of the present disclosure, an electronic device is provided, including: at least one processor; and a memory communicatively connected to the at least one processor, where the memory stores instructions executable by the at least one processor, and the instructions are configured to, when executed by the at least one processor, cause the at least one processor to implement the method described above.

According to another aspect of the present disclosure, a non-transitory computer-readable storage medium having computer instructions therein is provided, and the computer instructions are configured to cause a computer to implement the method described above.

According to another aspect of the present disclosure, a computer program product containing a computer program is provided, the computer program when executed by a processor is configured to cause the processor to implement the method described above.

It should be understood that content described in this section is not intended to identify key or important features in embodiments of the present disclosure, nor is it intended to limit the scope of the present disclosure. Other features of the present disclosure will be easily understood through the following description.

### BRIEF DESCRIPTION OF THE DRAWINGS

The accompanying drawings are used for better understanding of the solution and do not constitute a limitation to the present disclosure. In the accompanying drawings:

FIG. 1 schematically shows an exemplary system architecture to which an image search method and apparatus may be applied according to embodiments of the present disclosure;

FIG. 2 schematically shows a flowchart of an image search method according to embodiments of the present disclosure;

FIG. 3 schematically shows a scenario diagram of determining a search information according to an embodiment of the present disclosure;

FIG. 4 schematically shows a scenario diagram of acquiring an input information according to embodiments of the present disclosure;

FIG. 5 schematically shows a scenario diagram of determining at least one target image according to an embodiment of the present disclosure;

FIG. 6A schematically shows a scenario diagram of generating a second description information according to an embodiment of the present disclosure;

FIG. 6B schematically shows a scenario diagram of generating a second description information according to another embodiment of the present disclosure;

FIG. 7 schematically shows a scenario diagram of determining a target image from a search image library according to an embodiment of the present disclosure;

FIG. 8 schematically shows a scenario diagram of determining a target image according to an embodiment of the present disclosure;

FIG. 9 schematically shows a block diagram of an image search apparatus according to an embodiment of the present disclosure;

FIG. 10 schematically shows a structural block diagram of an intelligent agent of artificial intelligence according to embodiments of the present disclosure; and

FIG. 11 schematically shows a block diagram of an electronic device 1100 suitable for implementing the image search method according to embodiments of the present disclosure.

### DETAILED DESCRIPTION OF EMBODIMENTS

Exemplary embodiments of the present disclosure will be described below with reference to accompanying drawings, which include various details of embodiments of the present disclosure to facilitate understanding and should be considered as merely exemplary. Therefore, those ordinary skilled in the art should realize that various changes and modifications may be made to embodiments described herein without departing from the scope and spirit of the present disclosure. Likewise, for clarity and conciseness, descriptions of well-known functions and structures are omitted in the following description.

At present, large model-based image search tasks include text-based image retrieval tasks, composed image retrieval (CIR) tasks, and chat-based image retrieval (Chat-IR) tasks, whose inputs are respectively a text input in a pure language modality, a multimodal input combining reference images and text instructions, and a text input combined by multiple rounds of dialogues.

On the one hand, as different tasks require diverse input forms, traditional single-modality image search methods need to design different model architectures and optimization strategies for various tasks, which increases complexity and computational costs of systems. In addition, such a separated design increases complexity of systems, requiring systems to adapt across different tasks and causing additional development and maintenance costs.

On the other hand, with a diversification of user needs, application scenarios of image search are not limited to a single task mode. In complex application scenarios, user's image search needs may be cross-task or changing dynamically. For example, the user may initially only want a simple image search through text, but as an interaction deepens, the user may require the system to further optimize a search result in combination with a reference image or through a dialogue. Existing image search methods, due to their design of separating tasks, are difficult to flexibly handle such cross-task and complex dynamic needs, thereby causing a poor image search experience in complex scenarios.

Embodiments of the present disclosure provide an image search method, including: determining a multimodal search information according to an input information for image search, where the input information includes a first text information and/or a first reference image, and the search information includes a second text information and a second reference image; performing, by using a text analysis large model, a text analysis on the second text information and a first description information describing the second reference image to generate at least one second description information; and determining at least one target image according to the at least one second description information, where each of the at least one target image is determined according to the at least one second description information. According to embodiments of the present disclosure, it is possible to reduce the system complexity and maintenance costs and improve the search experience.

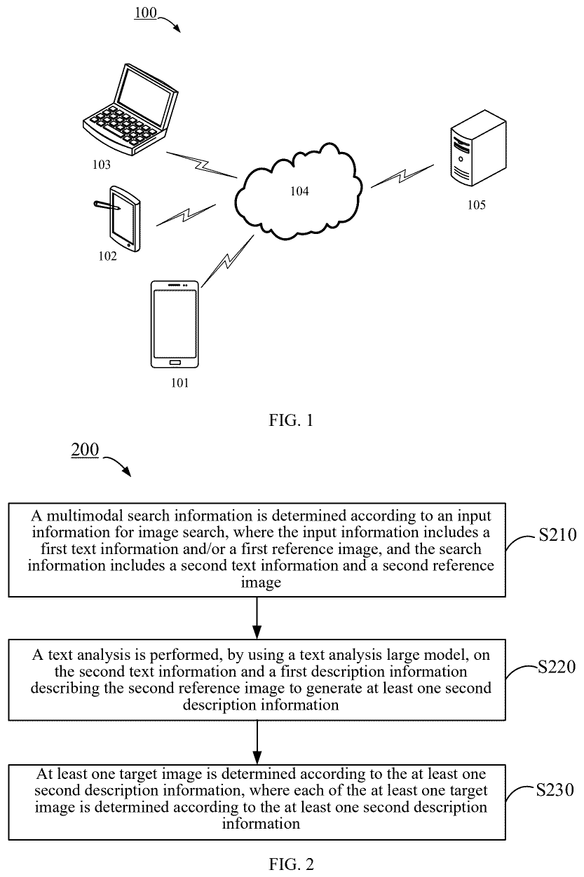

FIG. 1 schematically shows an exemplary system architecture to which an image search method and apparatus may be applied according to embodiments of the present disclosure.

It should be noted that FIG. 1 is merely an example of the system architecture to which embodiments of the present disclosure may be applied, so as to help those skilled in the art understand technical contents of the present disclosure. However, it does not mean that embodiments of the present disclosure may not be applied to other devices, systems, environments or scenarios. For example, in another embodiment, the exemplary system architecture to which the image search method and apparatus may be applied may include a terminal device, but the terminal device may implement the method and apparatus provided in embodiments of the present disclosure without interacting with a server.

As shown in FIG. 1, the system architecture 100 according to such embodiments may include a first terminal device 101, a second terminal device 102, a third terminal device 103, a network 104, and a server 105. The network 104 is a medium for providing a communication link between the terminal device 101, the terminal device 102, the terminal device 103 and the server 105. The network 104 may include various connection types, such as wired and/or wireless communication links, etc.

The first terminal device 101, the second terminal device 102 and the third terminal device 103 may be used by users to interact with the server 105 through the network 104 to receive or send messages, etc. The first terminal device 101, the second terminal device 102 and the third terminal device 103 may be installed with various communication client applications, such as knowledge reading applications, web browser applications, search applications, instant messaging tools, email clients and/or social platform software, etc. (for example only).

The first terminal device 101, the second terminal device 102 and the third terminal device 103 may be various electronic devices having display screens and supporting web browsing, including but not limited to smart phones, tablet computers, laptop computers, and desktop computers, etc.

The server 105 may be a server providing various services, such as a background management server (for example only) that provides a support for content browsed by users using the first terminal device 101, the second terminal device 102 and the third terminal device 103. The background management server may analyze and process received data such as a user request, and feed back a processing result (such as a web page, information or data acquired or generated according to the user request) to the terminal devices.

The server 105 may be a cloud server, also known as a cloud computing server or a cloud host, which is a host product in a cloud computing service system to solve shortcomings of difficult management and weak service scalability existing in a conventional physical host and VPS (Virtual Private Server) service. The server 105 may also be a server of a distributed system or a server combined with a block-chain.

It should be noted that the image search method provided in embodiments of the present disclosure may generally be performed by the terminal device 101, the terminal device 102 and the terminal device 103. Accordingly, the image search apparatus provided in embodiments of the present disclosure may also be arranged in the terminal device 101, the terminal device 102 and the terminal device 103.

Alternatively, the image search method provided in embodiments of the present disclosure may generally be performed by the server 105. Accordingly, the image search apparatus provided in embodiments of the present disclosure may generally be arranged in the server 105. The image search method provided in embodiments of the present disclosure may also be performed by a server or server cluster different from the server 105 and capable of communicating with the terminal device 101, the terminal device 102, the terminal device 103 and/or the server 105. Accordingly, the image search apparatus provided in embodiments of the present disclosure may also be arranged in a server or server cluster different from the server 105 and capable of communicating with the terminal device 101, the terminal device 102, the terminal device 103 and/or the server 105.

For example, the user is allowed to input an input information for image search through the first terminal device 101, the second terminal device 102 and the third terminal device 103. The first terminal device 101, the second terminal device 102 and the third terminal device 103 may be used to: determine a multimodal search information according to the input information for image search, where the input information includes a first text information and/or a first reference image, and the search information includes a second text information and a second reference image; perform, by using a text analysis large model, a text analysis on the second text information and a first description information describing the second reference image to generate at least one second description information; and determine at least one target image according to the at least one second description information, where each of the at least one target image is determined according to the at least one second description information.

Alternatively, the input information for image search may be sent to the server 105 through the first terminal device 101, the second terminal device 102 and the third terminal device 103, and the above-mentioned image search method may be performed using the server 105 to determine and return at least one target image to the first terminal device 101, the second terminal device 102 and the third terminal device 103.

It should be understood that the number of terminal devices, networks and servers in FIG. 1 is merely illustrative. According to implementation needs, any number of terminal devices, networks and servers may be provided.

In technical solutions of the present disclosure, a collection, a storage, a use, a processing, a transmission, a provision, a disclosure, an application and other processing of user personal information involved comply with provisions of relevant laws and regulations, take necessary security measures, and do not violate public order and good customs.

In the technical solutions of the present disclosure, the acquisition or collection of user personal information has been authorized or allowed by users.

FIG. 2 schematically shows a flowchart of an image search method according to embodiments of the present disclosure.

As shown in FIG. 2, a method 200 includes operation S210 to operation S230.

In operation S210, a multimodal search information is determined according to an input information for image search, where the input information includes a first text information and/or a first reference image, and the search information includes a second text information and a second reference image.

The input information may be in a single modality, such as a first text information in a single language modality or a first reference image in a single visual modality. Alternatively, the input information may be a multimodal input information, such as the first text information and the first reference image. For example, the input information may be a pure text input for a text-based image retrieval task, an input of reference images and text instructions for a composed image retrieval task, or a combined text input from multiple rounds of dialogues for a chat-based image retrieval task.

For example, the input information may include the first text information, such as “a girl is playing with a white cat”; or the input information may include the first reference image, such as an image representing “a girl is playing with a black cat”; or the input information may include both the first text information and the first reference image, where the first reference image is an image representing “a girl is playing with a black cat” and the first text information is “modify the black cat to a white cat”.

The search information is in a multimodal form and includes both the second text information and the second reference image. It may be understood that the search information may be an information obtained by performing a standardization on the input information in various forms, where the standardization may involve unification in terms of modality, form, size, etc. For example, in terms of the unification of modality, both the single-modal input form and the multimodal input form may be processed into a multimodal form including the second text information and the second reference image, so as to obtain a multimodal search information.

For example, it is possible to directly use the first text information as the second text information, or process the first text information to obtain the second text information, or use a predetermined type of second text information. For example, it is possible to perform operations, such as modifications, sentence pattern conversions, sentence segmentation or information extraction, on the first text information to obtain the second text information.

For another example, it is possible to directly use the first reference image as the second reference image, or process the first reference image to obtain the second reference image, or use a predetermined type of second reference image. For example, it is possible to perform operations, such as cropping, rotations, color corrections, etc., on the first reference image to obtain the second reference image.

In operation S220, a text analysis is performed on the second text information and a first description information describing the second reference image by using a text analysis large model to generate at least one second description information.

The first description information of the second reference image is used to describe content of the second reference image. For example, the first description information is used to describe elements, attributes, spatial relationships and other information with linguistic meanings in the second reference image. Elements may include objects such as people, animals, plants, articles, etc. Attributes may refer to features of elements that may distinguish elements, such as colors, shapes, sizes, etc. Spatial relationships may be understood as relative positional relationships between elements.

The text analysis large model may be a large language model (LLM) used to process a language modality. In the embodiment, the text analysis large model may be a pre-trained large language model.

By using the text analysis large model, a semantic analysis may be performed on the first description information and the second text information from a perspective of text, so as to synthesize semantics of the two to determine the second description information. The second description information is a description information of an image that meets user's image search needs.

In an embodiment, the text analysis may be performed once on the second text information and the first description information using the text analysis large model to obtain a single second description information. Alternatively, the text analysis may be performed multiple times on the same information using the text analysis large model to obtain the second description information that meets user's image search needs and has multiple forms of expression.

In another embodiment, the text analysis may be performed once on the second text information and the first description information using the text analysis large model, to generate at least one second description information in at least one form. It is also possible to generate at least one second description information with at least one semantic granularity.

For example, if the first reference image is an image representing “a girl is playing with a black cat” and the first text information is “modify the black cat to a white cat”, the second description information output by the text analysis large model may be “a girl is playing with a white cat”.

In operation S230, at least one target image is determined according to the at least one second description information, where each of the at least one target image is determined according to the at least one second description information.

The at least one second description information may be regarded as a description information of an image that meets user's image search needs. Thus, it is possible to search for the target image in combination with all or part of the at least one second description information.

For example, it is possible to search for a candidate image according to each second description information, and determine at least one target image according to the number of second description information hit by the searched candidate image.

Alternatively, it is possible to calculate a similarity between each second description information and a candidate image, and synthesize similarities between one or more second description information and the same candidate image to determine whether to use the candidate image as a target image.

In embodiments of the present disclosure, as the input information in multiple forms is unified into a multimodal search information, the image search may be performed based on the input information in multiple tasks, cross-task scenarios and dynamically-changing modalities, without the need to design multiple processing flows, thereby simplifying the system complexity and flexibly coping with different tasks to meet user needs in various image search scenarios. In addition, by performing a text analysis on the second text information and the first description information using the text analysis large model to generate at least one second description information and determining each target image according to the at least one second description information, it is possible to fully utilize a rich second description information output by the text analysis large model to improve an accuracy of image search.

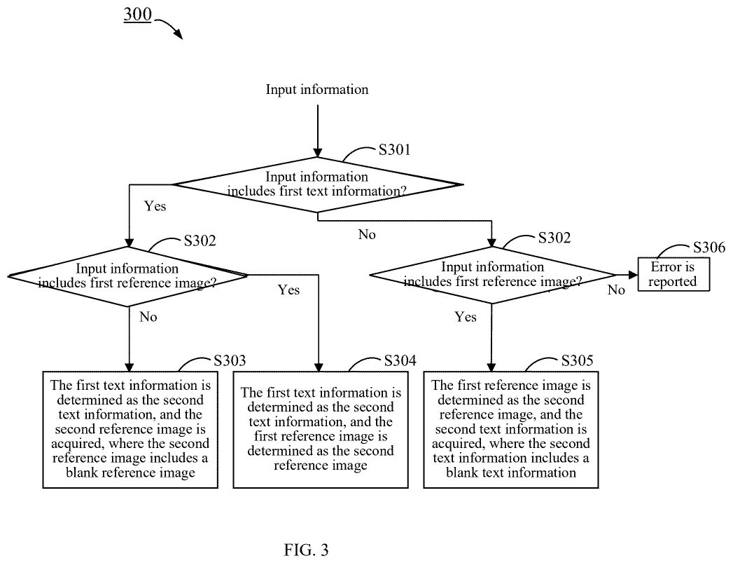

FIG. 3 schematically shows a scenario diagram of determining a search information according to an embodiment of the present disclosure.

As shown in FIG. 3, embodiment 300 includes operation S301 to operation S306, which may serve as an embodiment of operation S210.

In operation S301, it is determined whether the input information includes the first text information. After the input information is acquired, regardless of whether the input information includes the first text information or not, operation S302 is performed to further determine whether the input information includes the first reference image.

In operation S302, it is determined whether the input information includes the first reference image. If the input information includes the first text information but does not include the first reference image, operation S303 is performed. If the input information includes both the first text information and the first reference image, operation S304 is performed. If the input information does not include the first text information but includes the first reference image, operation S305 is performed. If the input information includes neither the first text information nor the first reference image, operation S306 is performed.

In operation S303, the first text information is determined as the second text information, and the second reference image is acquired, where the second reference image includes a blank reference image.

If the input information includes only the first text information, the input information is in a single language modality. The first text information may be determined as the second text information to constitute the multimodal search information together with a predetermined second reference image.

In an embodiment, the blank reference image may be an image that does not include any content. For example, the first description information of the blank reference image may be “blank image”.

In operation S304, the first text information is determined as the second text information, and the first reference image is determined as the second reference image.

If the input information includes both the first text information and the first reference image, the input information is a multimodal input and may be directly used as the search information.

For example, the input information includes the first reference image, which is an image representing “a girl is playing with a black cat”, and the input information further includes the first text information of “modify the black cat to a white cat”. The multimodal search information may then include an image representing “a girl is playing with a black cat” and a text of “modify the black cat to a white cat”.

In operation S305, the first reference image is determined as the second reference image, and the second text information is acquired, where the second text information includes a blank text information.

If the input information includes only the first reference image, the input information is in a single visual modality. The first reference image may be determined as the second reference image to constitute the multimodal search information together with a predetermined second text information.

In an embodiment, the blank text information may be an empty information that does not include any text, or may be a predetermined text information that represents no text instructions. For example, the blank text information may be “empty”, “no text instructions”, or the like.

In operation S306, an error is reported. When the input information includes neither the first text information nor the first reference image, it may be regarded as an invalid input, and an error may be reported.

In an embodiment, a prompt information of the text analysis large model may include two placeholders for the language modality and the visual modality. First, the first text information and/or the first reference information in the input information are/is filled into the placeholder(s) as the second text information and/or the second reference image. For the placeholder with no content, the blank reference image and/or the blank text information may be then filled in as the second reference image and/or the second text information.

In embodiments of the present disclosure, for the input text information in the single language modality or in the single visual modality, by filling in a blank second reference image or a blank second text information, the image search task may be changed from a single-modality input form to a unified multimodal form without affecting a semantic content, which enables a semantic analysis under the same input using the text analysis large model, thereby achieving a compatibility with multiple image search tasks and reducing the system complexity and maintenance costs.

In an embodiment, the input information may also be information in other modality in addition to the language modality and the visual modality. The information in other modality may be converted into the first text information in the language modality and/or the first reference image in the visual modality, thereby achieving compatibility with image search tasks of other modalities.

For example, for a speech information in an audio modality, the speech information may be converted into the first text information through a speech-to-text processing algorithm; and then the search information may be determined according to the input information.

In embodiments of the present disclosure, by converting the information in other modality input by the user into the input information, the image search method in the above-mentioned embodiments is not only applicable to a wider range of application scenarios, but also does not need a system flow modification for information in a new modality. Instead, the processing flow of the multimodal search information may be reused, thereby improving scalability and flexibility of the system.

According to embodiments of the present disclosure, for operation S210, the image search method further includes: determining an indicated image library as a search image library to determine the target image from the search image library when the input information includes the indicated image library; and determining a reference image library as the search image library when the input information does not include the indicated image library.

For example, the indicated image library may be one of image libraries included in the system that performs the image search method. The user is allowed to limit a search scope by adding the indicated image library to the input information. In the case that the input information does not include the indicated image library, the system may use a default reference image library.

For example, in a language-guided image search scenario, the input of the image search is a scoring function S=Ψ( [symbol] , Iᵣ, [symbol] ), where [symbol] represents a second text information in the language modality, Iᵣ represents a second reference image in the visual modality, [symbol] represents a search image library,

$$= {\{ {I}_{i} \}}_{í = 1}^{N} ,$$

for example, the search image library may include N candidate images. In a text-based image retrieval task, [symbol] may be [symbol] _{desc}. In a composed image retrieval task, [symbol] may be [symbol] ᵢₙₛₜ. In a chat-based image retrieval task, [symbol] may be [symbol] _{dialog}, [symbol] _{dialog}={d₁, d₂, . . . }, representing multiple rounds of dialogues, and dᵢ represents a text information composed of a round of dialogue.

In embodiments of the present disclosure, by determining whether the input information includes the indicated image library, the need of limiting the search scope may be fulfilled, which expands the application scenario and provides good user experience. In addition, for an input without limiting the search scope, a predetermined reference image library may be used for subsequent image search, so as to meet various image search needs of users.

According to embodiments of the present disclosure, the input information is obtained by at least one of: determining the first text information and/or the first reference image based on an input text and an input image in at least one round of dialogue; and determining the first reference image and/or the first text information based on at least one output image and/or the input text in at least one round of dialogue, where the output image is the target image determined and output according to the input information prior to the output image.

To facilitate understanding, four embodiments will be taken as examples below to describe the input information acquired in a language-guided image search scenario.

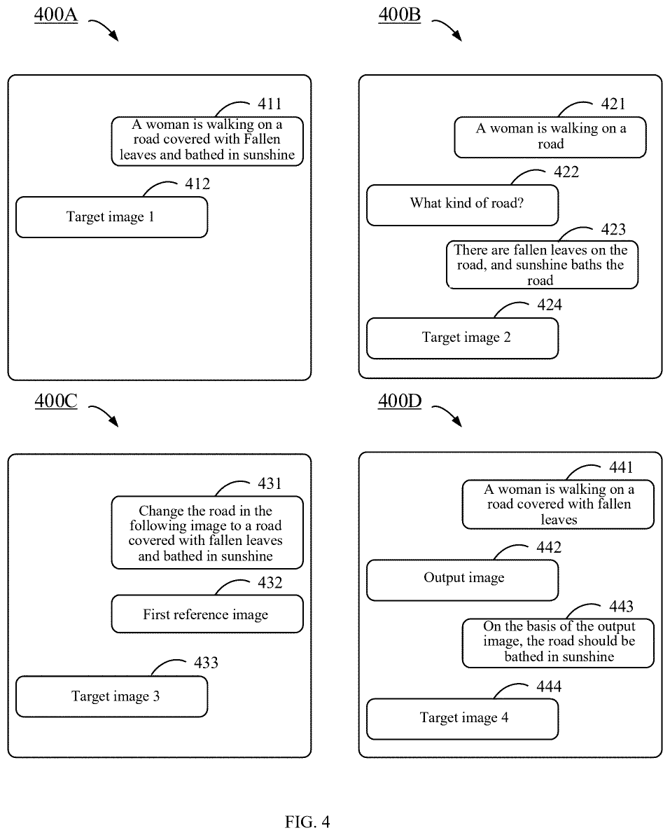

FIG. 4 schematically shows a scenario diagram of acquiring an input information according to embodiments of the present disclosure. As shown in FIG. 4, the four embodiments include embodiment 400A, embodiment 400B, embodiment 400C, and embodiment 400D.

In embodiment 400A, an input text 411 is acquired through a round of dialogue, such as “a woman is walking on a road covered with fallen leaves and bathed in sunshine”, and the input text 411 is determined as the first text information. In this embodiment, by using the image search method described above, a target image 1 412 is determined according to the input information including the first text information.

Similarly, an input image may be acquired through a round of dialogue and determined as the first reference image in the input information, so as to search for a corresponding target image according to the current input.

In embodiment 400B, specific requirements of the image search are clarified through two rounds of dialogues. For example, the specific requirements of the image search may be clarified by an input text 421, a system output question 422, and an input text 423. In this case, a first text information may be obtained by combining the input text 421 and the input text 423, such as “a woman is walking on a road. There are fallen leaves on the road, and sunshine baths the road”. The system output question 422 may be a question generated using a large conversational model to clarify the requirements for the road, such as “what kind of road?”. In this embodiment, by using the image search method described above, a target image 2 424 may be determined according to “a woman is walking on a road. There are fallen leaves on the road, and sunshine baths the road”.

In embodiment 400C, an input information including the first text information and the first reference image may be obtained through an input text 431 and an input image 432 in a round of dialogue. In this case, the first text information is the input text 431, such as “change the road in the following image to a road covered with fallen leaves and bathed in sunshine”. In this embodiment, a target image 3 433 may be determined based on the input information including the first text information and the first reference image.

In embodiment 400D, in a round of dialogue, a first text information is determined based on an input text 441, such as “a woman is walking on a road covered with fallen leaves”. By using the image search method described above, a target image may be determined according to an input information including the first text information, and the target image is output as a result, such as an output image 442. In this embodiment, the user initially only wanted a simple image search by text, but with a deeper interaction, the user initiated a second round of dialogue, hoping to further optimize the image search result by combining a reference image. In the second round of dialogue, an input text 443 may be “on the basis of the output image above, the road should be bathed in sunshine”. At this time, according to the input text 443, the output image 442 may be determined as the first reference image. The image search method described above may be performed again to determine a new target image 444, such as a target image 4, according to the input information including the first text information and the first reference image.

In embodiments of the present disclosure, input information in multiple image search tasks, cross-task scenarios or dynamically-changing modalities may be unified to a multimodal search information, so as to be applicable to a wider range of scenarios, meet more image search needs of users, and improve the user experience.

According to embodiments of the present disclosure, for operation S220, the text analysis large model is used to perform a first description generation task, and performing a text analysis on the second text information and the first description information describing the second reference image by using the text analysis large model to generate at least one second description information includes: performing the first description generation task using the text analysis large model, so as to perform a semantic analysis on the second text information and the first description information to generate the second description information with a plurality of semantic granularities, where the semantic granularities are related to the number and/or attributes of elements in the second description information, and the elements are extracted from the second text information and/or the first description information.

The first description generation task includes: understanding the second text information, and generating the second description information with the plurality of semantic granularities that meets user's image search needs, with the first description information as a reference.

A single input text from the user may contain multiple semantics, such as an operation on multiple elements, multiple operations on an element, multiple descriptions of an element, etc. Thus, the first description generation task may be performed using the text analysis large model to generate the second description information with the plurality of semantic granularities, so as to generate a clear and rich second description information.

The second description information with the plurality of semantic granularities may be understood as a plurality of second description information with a plurality of information amounts, where the information amount may refer to the number of elements or attributes in the second description information. The less the number of elements and/or the number of attributes, the finer the semantic granularity. Conversely, the more the number, the coarser the semantic granularity.

Taking three semantic granularities as an example, a first semantic granularity refers to core elements (CE), a second semantic granularity refers to enhanced details (ED), and a third semantic granularity refers to comprehensive synthesis (CS). The first semantic granularity may include only elements appearing in the second text information without using attributes, where the attributes may be regarded as adjectives, adverbials, attributes, and the like in the second text information. The second semantic granularity may include only elements appearing in the second text information and use necessary attributes from the second description information. The third semantic granularity may include elements appearing in the second text information and related elements in the first description information, and use necessary attributes. It may be understood that the first semantic granularity, the second semantic granularity and the third semantic granularity increase progressively.

In an example, the second text information is “the person should be holding a baby”, and the first description information of the second reference image is “a woman with black hair is smiling under a gray umbrella, with a white flower hanging from the umbrella”. The second description information with the first semantic granularity generated by the text analysis large model is “a woman is holding a baby”, the second description information with the second semantic granularity is “a woman with black hair is holding a baby under an umbrella”, and the second description information with the third semantic granularity is “a woman with black hair is holding a baby and smiles under a gray umbrella”. The second description information with the first semantic granularity includes only the elements in the second text information, such as “person” and “baby”. The second description information with the second semantic granularity includes only the elements “person” and “baby” as well as corresponding attributes “black hair” and “under an umbrella”. The second description information with the third semantic granularity includes the elements “person” and “baby” as well as the attribute “gray” of the related element “umbrella” in the first description information.

In embodiments of the present disclosure, by performing the first description generation task using the text analysis large model to generate the second description information with the plurality of semantic granularities for the same input, a semantic hierarchy of the second description information may be enriched, which facilitates a subsequent determination of target image in a wider range by using the second description information with the plurality of semantic granularities, thereby improving the accuracy of image search.

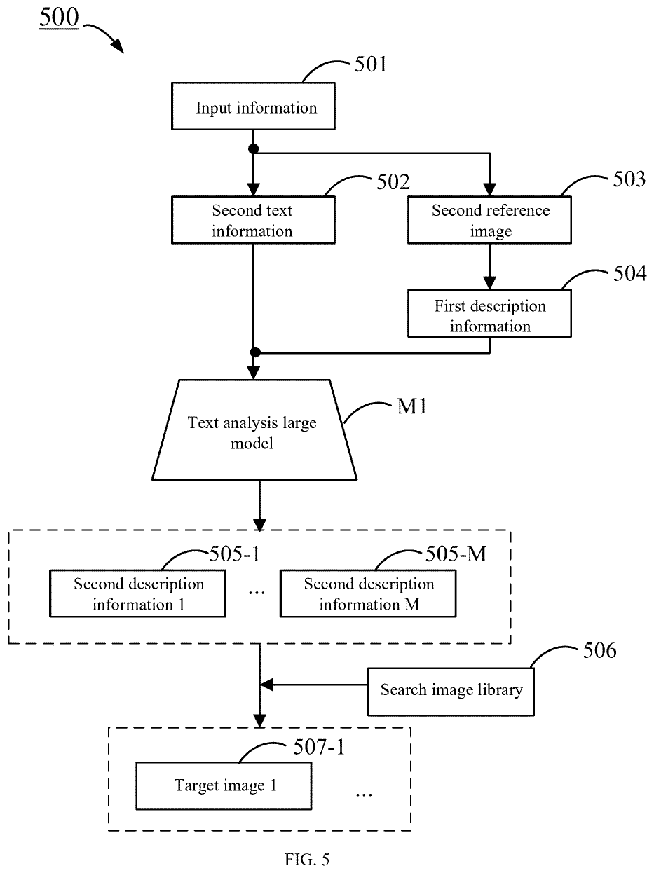

FIG. 5 schematically shows a scenario diagram of determining at least one target image according to an embodiment of the present disclosure.

As shown in FIG. 5, in embodiment 500, a second text information 502 and a second reference image 503 are determined according to whether an input information 501 includes the first text information and/or the first reference image information.

After a first description information 504 for describing a second reference image 503 is acquired, a text analysis is performed on the first description information 504 and a second text information 502 using a text analysis large model M1 to obtain at least one second description information, such as a second description information 1 505-1 . . . a second description information M 505-M. By using the second description information 1 505-1 . . . the second description information M 505-M, at least one target image, such as a target image 1 507-1, may be filtered from an image search library 506.

According to embodiments of the present disclosure, for operation S220, performing the first description generation task using the text analysis large model so as to perform the semantic analysis on the second text information and the first description information to generate the second description information with the plurality of semantic granularities includes: acquiring a prompt information, where the prompt information includes the plurality of semantic granularities to be generated and an explanation information for each semantic granularity; and performing the first description generation task using the text analysis large model, so as to perform a semantic analysis on the second text information and the first description information based on each semantic granularity to generate a second description information at each semantic granularity.

For example, a prompt information A may be as follows.

#Task description: You will be provided with a description for image search. The first description generation task is to combine a second text information and an information in a second reference image or first description information to accurately search for images. #First description generation task: Describe what the target image should look like according to an analysis on text instructions and reference images. Provide three sentences to describe the target image, with each sentence focusing on a different semantic granularity: (1) The first semantic granularity refers to core elements, which may include only the elements appearing in the second text information without using attributes. (2) The second semantic granularity refers to enhanced details, which include only the elements appearing in the second text information and use necessary attributes from the second description information. (3) The third semantic granularity refers to comprehensive synthesis, which includes the elements appearing in the second text information and related elements in the first description information, and uses necessary attributes. I will give you the second text information and the first description information, and you are required to execute the task according to the information. ###Search: second text information [[instructions]], first description information [[reference image description]].

In the embodiments, [[instruction]] and [[reference image description]] are placeholders. “Core elements”, “enhanced details” and “comprehensive synthesis” are names of semantic granularities. “Include only the elements appearing in the second text information without using attributes” is an explanation information for a corresponding semantic granularity.

For another example, the prompt information may include not only the above-mentioned content but also a task example to help the large text analysis perform the first description generation task better.

In embodiments of the present disclosure, by writing the semantic granularity and the explanation information for the semantic granularity in the prompt information and performing the first description generation task using the text analysis large model, it is possible to perform a semantic analysis on the second text information and the first description information based on each semantic granularity to generate the second description information at each semantic granularity, thereby generating a rich second description information.

Taking FIG. 5 as an example, the text analysis large model M1 may perform the first description generation task, and the obtained second description information 1 507-1 . . . belong to a plurality of semantic granularities.

According to embodiments of the present disclosure, for operation S220, the text analysis large model is used to sequentially perform an operation generation task and a second description generation task, and performing a text analysis on the second text information and the first description information describing the second reference image by using the text analysis large model to generate at least one second description information includes: performing the operation generation task using the text analysis large model to generate an operation prompt information according to a difference between the first description information and the second text information, where the operation prompt information includes at least one operation of at least one operation type; and performing the second description generation task using the text analysis large model to generate the at least one second description information according to the operation prompt information and the first description information.

The text input by the user may contain multiple semantics. For example, the second text information includes multiple elements, multiple attributes and multiple operations. If generating the second description information using the text analysis large model directly based on the entire second text information, it is possible to generate an inaccurate second description information. Thus, in the embodiment, a process of generating the second description information is divided into two tasks: the operation generation task and the second description generation task.

The operation generation task may be a classification task for comparing the first description information and the second text information, and determining an operation to be performed on the first description information as well as an operation type according to a difference between the first description information and the second text information.

The operation prompt information may be a benchmark for performing the second description generation task, which may be used to prompt the text analysis large model to perform the second description generation task, so as to generate at least one second description information.

The operation type in the operation prompt information may include Addition type, Removal type, Modification type, Comparison type, and Retention type.

In an embodiment, when the text analysis large model sequentially performs the operation generation task and the second description generation task, the prompt information used may include an operation type and an explanation information for the operation type.

For the second reference image described by the second description information, the explanation information for the operation type may be as follows: addition may be understood as introducing new elements or attributes into the second reference image; removal may be understood as removing some elements or attributes from the second reference image; modification may be understood as changing attributes of existing elements in the second reference image; comparison refers to comparing the elements in the second reference image with the elements in the first text information using words such as “different”, “same”, “more” or “less”; and retention is to specify that some existing elements or attributes in the second reference image remain unchanged.

The operation prompt information obtained after performing the operation generation task may include the second text information, in which an operation type is newly added.

For example, in an embodiment, the second text information is “the person should be holding a baby” and the first description information of the second reference image is “a woman with black hair is smiling under a gray umbrella, with a white flower hanging from the umbrella”. The operation prompt information is “Addition: a woman holding a baby”, the operation is to add “a woman holding a baby” to the second reference image, and the operation type is “Addition”. The “a woman holding a baby” included in the operation prompt information contains the second text information “the person should be holding a baby” and provides a more specific and accurate expression.

The second description generation task is similar to the first description generation task, but it performs an explicit operation according to the operation type clarified in the operation prompt information, which will not be described in detail here.

In embodiments of the present disclosure, the operation generation task and the second description generation task are sequentially performed using the large text analysis large to generate the operation prompt information with clearer semantic meaning; and at least one second description information is generated according to the operation prompt information and the second text information. By extracting a more explicit operation with finer granularity and an operation type from a complex second text information through two tasks, the generated second description information is more in line with the image search needs and may help improve the accuracy of image search.

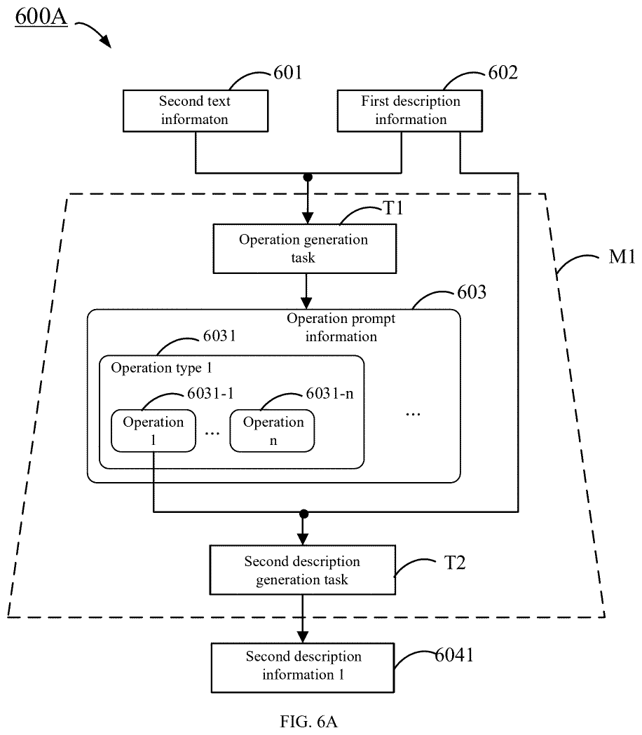

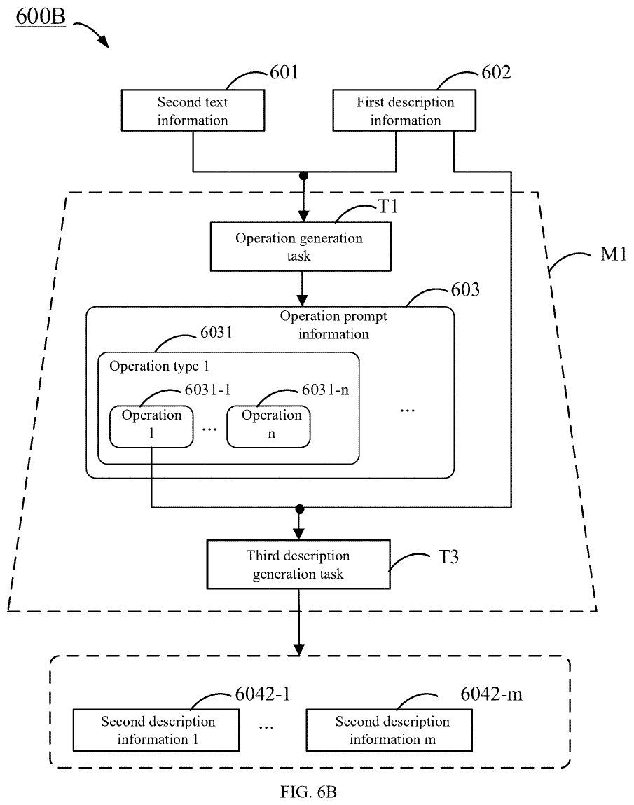

FIG. 6A schematically shows a scenario diagram of generating a second description information according to an embodiment of the present disclosure. As shown in FIG. 6A, in embodiment 600A, the text analysis large model M1 sequentially performs an operation generation task T1 and a second description generation task T2.

For example, the operation generation task T1 is performed using the text analysis large model M1 to generate an operation prompt information 603 according to a second text information 601 and a first description information 602. The operation prompt information 603 may include at least one operation of at least one operation type, such as operation 1 6031-1 . . . operation n 6031-n of operation type 1 6031.

Taking operation 1 6031-1 as an example, the second description generation task T2 is performed using the text analysis large model M1 to obtain a second description information 1 6041 according to the operation 1 6031-1 and the first description information 602.

In other embodiments, the operation prompt information may include only one operation of one operation type.

According to embodiments of the present disclosure, the operation type of the at least one operation in the operation prompt information is addition type when the second reference image is a blank reference image.

For an image search task in a single language modality, the input information includes only the first text information, and the second reference image of the search information determined according to the input information is a blank reference image. In this case, a difference between the second text information and the first description information of the second reference image is the entire content of the second text information. Accordingly, the operation types of the operations on the elements and/or attributes in the second text information are all Addition types.

For example, the second text information may be “the person is holding a baby, and the baby is wearing pink clothes”, and the second reference image is a blank reference image. The operation prompt information obtained by performing the operation generation task may be as follows: 1. addition: a person is holding a baby; 2. addition: a baby is wearing pink clothes. The second description information generated according to the operation prompt information and the first description information may be “a person is holding a baby wearing pink clothes”.

In a case that the second text information is a blank text information, the operation type of the operation included in the operation prompt information may be retention type and/or comparison type. For example, in the case that the second text information is a blank text information, the first description information of the second reference image may be “a person is holding a baby, and the baby is wearing pink clothes”. The operation prompt information obtained by performing the operation generation task may be: 1. retention: a person is holding a baby; 2. retention: a baby is wearing pink clothes. The second description information generated according to the operation prompt information and the first description information may be “a person is holding a baby wearing pink clothes”.

In embodiments of the present disclosure, in a case of a blank second reference image or a blank second text information, the image search task may still be normally performed using the text analysis large model, and a target image semantically similar to a non-blank second text information or a non-blank second reference image may be obtained, which may be applied in a wide range of scenarios.

According to embodiments of the present disclosure, the text analysis large model is used to sequentially perform an operation generation task and a third description generation task, and performing a text analysis on the second text information and the first description information describing the second reference image by using the text analysis large model to generate at least one second description information includes: performing the operation generation task using the text analysis large model to generate an operation prompt information according to a difference between the first description information and the second text information; and performing the third description generation task using the text analysis large model to generate the second description information with a plurality of semantic granularities according to the operation prompt information and the first description information.

The operation generation task is similar to the above-mentioned operation generation task, the third description generation task is similar to the second description generation task, and the second description information is generated according to the operation prompt information and the first description information. When generating the second description information, the third description generation task, similar to the first description generation task, may be performed to generate a second description information with a plurality of semantic granularities. For detailed operations, reference may be made to the above description, which will not be repeated here.

When the text analysis large model sequentially performs the operation generation task and the third description generation task, the prompt information used may include the plurality of semantic granularities to be generated and an explanation information for each semantic granularity, and may further include the operation type and the explanation information for the operation type.

For example, a prompt information B used by the text analysis large model to sequentially perform the operation generation task and the third description generation task may be as follows.

#Task description: You will be provided with a description for image search. The task is to combine a second text information and an information in a second reference image or first description information to accurately search for images. You need to follow two steps to infer “what the target image should look like”: #Step 1: Classify a given second text information into the operation types as follows and determine how it affects the second reference image. For each operation type, determine elements or attributes in the second reference image that are affected. The operation types include: (1) addition, (2) removal, (3) modification and (4) comparison. (1) Addition: Introduce new elements or attributes into the second reference image. Determine which existing element the addition relates to or where the addition should be placed. (2) Removal: Remove some elements from the second reference image. Determine which existing element is removed. (3) Modification: Change attributes of existing elements in the second reference image. Determine which element is being modified and how to modify. (4) Comparison: Compare elements in the second reference image using terms such as “different”, “same”, “more” or “less”. Determine which elements and attributes are being compared. (5) Retention: Specify that some existing elements in the second reference image remain unchanged. Make sure to mark these elements as included in the target image. #Step 2: . . . “#Step 2: . . . ” is similar to “#First description generation task” in the prompt information A described above, which will not be repeated here.

In embodiments of the present disclosure, by sequentially performing the operation generation task and the third description generation task, the text analysis large model may perform tasks hierarchically to generate a more accurate second description information with richer semantic granularities, thereby improving an accuracy of the target image subsequently determined using the second description information with a plurality of semantic granularities.

FIG. 6B schematically shows a scenario diagram of generating a second description information according to another embodiment of the present disclosure. As shown in FIG. 6B, in embodiment 600B, the text analysis large model M1 sequentially performs an operation generation task T1 and a third description generation task T3. A method for generating operation 1 6031-1 . . . operation n 6031-n is similar to the method in the embodiment 600A and will not be repeated here.

Taking the operation 1 6031-1 as an example, the third description generation task T3 is performed by using the text analysis large model M1 to obtain a plurality of second description information with a plurality of semantic dimensions, such as second description inforformation 1 6042-1 . . . second description information m 6042-m.

According to embodiments of the present disclosure, for the operation generation task, generating the operation prompt information according to the difference between the first description information and the second text information includes: extracting at least one operation from the second text information and determining the operation type according to the difference between the first description information and the second text information; or extracting at least one initial operation from the second text information and determining the operation type according to the difference between the first description information and the second text information; and rewriting the initial operation using the first description information to obtain the operation.

The operation generation task may include an operation extraction task and a classification task. The operation extraction task is used to compare the first description information and the second text information, and extract one or more operations to be performed according to a difference between the first description information and the second text information. The extracted operations are then classified to generate operation types corresponding to the operations, so as to obtain the operation prompt information.

It is possible for the operation generation task to include an operation extraction task, a classification task and a rewriting task. By performing the operation extraction task and classification task described above, corresponding initial operation and operation type are generated; and then the initial operation is rewritten according to the first description information to obtain the operation.

For example, assuming that the second text information is “a person should be holding a baby”, the first description information of the second reference image is “a woman with black hair is smiling under a gray umbrella, with a white flower hanging from the umbrella”, the operation prompt information before rewriting is: 1. addition: a person is holding a baby, then it is possible to rewrite the initial operation “a person is holding a baby” according to the person “woman” in the first description information to obtain the operation prompt information: 1. addition: a woman is holding a baby.

In embodiments of the present disclosure, by rewriting the initial operation using the text analysis large model, it is possible to generate an operation prompt information with more explicit instructions, so as to subsequently generate a more accurate second description information according to the operation prompt information and the first description information.

According to embodiments of the present disclosure, for operation S230, determining at least one target image according to the at least one second description information includes: determining a similarity between the second description information and a third description information describing a candidate image, where the search image library includes a plurality of candidate images; determining a first comprehensive similarity for each candidate image according to the similarity with each second description information; and determining the at least one target image from the plurality of candidate images according to the first comprehensive similarity.

A search image library specified by the user or a default search image library includes a plurality of candidate images. At least one target image may be filtered from the plurality of candidate images in the search image library according to the second description information.

For example, the search image library may store a plurality of candidate images and the third description information describing each candidate image. For the second description information and the third description information in the language modality, a similarity may be calculated using existing similarity algorithms. Then, for each candidate image, a weighted sum of similarities between the third description information and each second description information is calculated to obtain a first comprehensive similarity for that candidate image. Alternatively, the first comprehensive similarity for each candidate image may be obtained according to the number of similarities reaching a particular threshold. After that, at least one target image is directly determined from the plurality of candidate images according to the first comprehensive similarity. For example, a candidate image having a high first comprehensive similarity is selected as the target image.

In embodiments of the present disclosure, the third description information in the language modality is used, and the similarity between the third description information and the second description information is calculated. By using the first comprehensive similarity obtained by synthesizing the above-mentioned similarities, it is possible to determine a target image with more accurate semantics in the same modality, and the search accuracy is higher.

According to embodiments of the present disclosure, for operation S230, determining at least one target image according to the at least one second description information includes: acquiring an image embedding feature of each candidate image in the search image library; determining a second comprehensive similarity for each candidate image according to a similarity between the image embedding feature and a text embedding feature of each second description information; and determining the at least one target image from the plurality of candidate images according to the second comprehensive similarity.

For example, it is possible to encode the second description information in the language modality using a text embedding model to obtain a text embedding feature, such as a text vector, and to encode the candidate image in the visual modality using an image embedding model to obtain an image embedding feature, such as an image vector.

Alternatively, it is also possible to encode the second description information and the candidate image using a multimodal large model to obtain a text embedding feature and an image embedding feature, respectively. For example, a vision-language model (VLM) including a visual encoder and a language encoder may encode the second description information and the candidate image respectively using an internal language encoder and an internal image encoder.

A similarity between each image embedding feature and the text embedding feature of each second description information may be calculated using existing vector similarity algorithms. For a single candidate image, a weighted sum of similarities between the image embedding feature and each second description information is calculated to obtain the second comprehensive similarity of each candidate image. Alternatively, the second comprehensive similarity of each candidate image may be obtained according to the number of similarities reaching a particular threshold. After that, at least one target image may be directly determined from the plurality of candidate images according to the second comprehensive similarity. For example, a candidate image having a high second comprehensive similarity is selected as the target image.

In embodiments of the present disclosure, the similarity between the image embedding feature of the candidate image and the text embedding feature of the second description information is used to determine the target image. Therefore, the selected target image may meet the image search needs from a visual perspective, and the accuracy of the target image from the visual perspective may be ensured.

According to embodiments of the present disclosure, the method further includes: determining a third comprehensive similarity of each candidate image according to a similarity between the third description information and each second description information and a similarity between an image embedding feature of the candidate image and a text embedding feature of each second description information; and determining the at least one target image from the plurality of candidate images according to the third comprehensive similarity.

Referring to the above-mentioned calculation methods, the similarity between the third description information and the second description information and the similarity between the image embedding feature and the text embedding feature may be obtained.

For ease of description, the above two similarities are referred to as a text-text similarity and a text-image similarity, respectively. For each candidate image, the third comprehensive similarity may be obtained by synthesizing the text-text similarity and text-image similarity between the candidate image and each second description information. After that, at least one target image may be directly filtered from the plurality of candidate images according to the third comprehensive similarity.

In an embodiment, it is possible to calculate a weighted sum of the text-text similarity and text-image similarity corresponding to each second description information according to the semantic granularity. A sum of the weighted sums of the plurality of semantic granularities may be divided by the number of semantic granularities to obtain the third comprehensive similarity. For example, when calculating the weighted sum of the text-text similarity and text-image similarity corresponding to each second description information, weights of the two may be controlled by a parameter [symbol] , so that a sum of the two weights is equal to 1.

In embodiments of the present disclosure, the third comprehensive similarity is obtained by synthesizing the text-text similarity and the text-image similarity. Therefore, the target image determined according to the third comprehensive similarity may meet the image search needs better from both text perspective and image perspective, thereby enhancing robustness and improving the accuracy of image search.

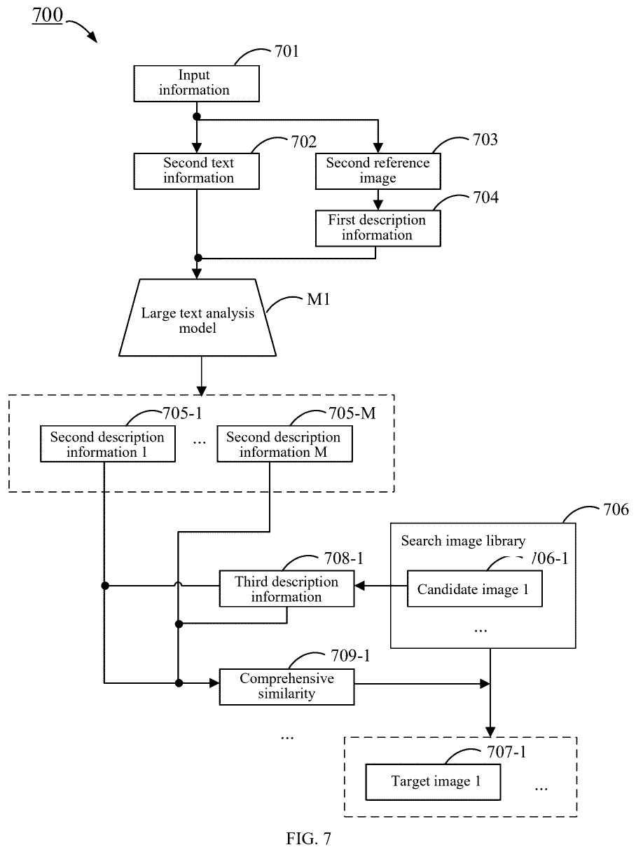

FIG. 7 schematically shows a scenario diagram of determining a target image from a search image library according to an embodiment of the present disclosure. As shown in FIG. 7, in embodiment 700, a second text information 702 and a second reference image 703 are determined according to whether an input information 701 includes the first text information and/or the first reference image information. After a first description information 704 describing the second reference image 703 is acquired, a text analysis is performed on the first description information 704 and the second text information 702 using the text analysis large model M1 to obtain at least one second description information, such as second description information 1 705-1 . . . second description information M 705-M.

A search image library 706 includes a plurality of candidate images, such as a candidate image 1 706-1 . . . . Taking the candidate image 1 706-1 as an example, for a third description information 708-1 describing the candidate image 1 706-1, a similarity between the third description information 708-1 and each second description information may be calculated, and a comprehensive similarity 709-1 corresponding to the candidate image 1 706-1 may be obtained according to the similarity between the third description information 708-1 and each second description information. For each candidate image, a corresponding comprehensive similarity may be obtained using the above-mentioned method.

After that, at least one target image, such as target image 1 707-1 . . . , is determined from the search image library 706 according to the comprehensive similarity of each candidate image.

The comprehensive similarity may be the first comprehensive similarity, the second comprehensive similarity, or the third comprehensive similarity.

According to embodiments of the present disclosure, the method further includes: converting the second reference image into the first description information using a description generation large model; and converting the candidate image into the third description information using the description generation large model.

The description generation large model may be a large multimodal model (LMM) used to convert an input in the visual modality into an output in the language modality For example, it may convert an input second image into a first description information and convert a candidate image into a third description information. The description generation large model may be a pre-trained large multimodal model.

In embodiments of the present disclosure, by generating the description information for a corresponding image using the description generation large model, the operation may be simplified, and the processing flow of the entire image search task may be more intelligent.

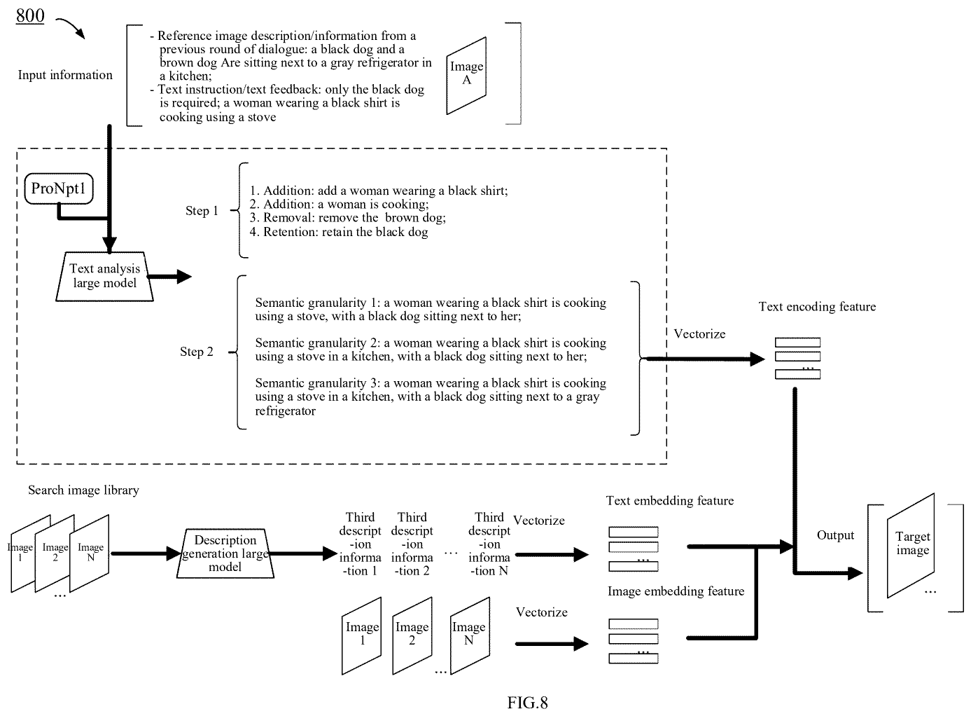

To facilitate understanding of the present disclosure, an embodiment will be taken as an example below to describe a process of image search. FIG. 8 schematically shows a scenario diagram of determining a target image according to an embodiment of the present disclosure.

As shown in FIG. 8, the input information may include a first text information “—Reference image description/information from a previous round of dialogue: a black dog and a brown dog are sitting next to a gray refrigerator in a kitchen.—Text instruction/text feedback: only the black dog is required; and a woman wearing a black shirt is cooking using a stove”. The input information further includes a first reference image, such as image A. In the embodiment, since the input image includes the first reference image, the second reference image in the search information is image A, which may be represented by Iᵣ.

The second reference image Iᵣ may be converted into a first description information Iᵣ using a large description generation large model Captioner, and a generation process may be expressed by Equation (1).

$${T}_{r} = Captioner ( {I}_{r} ) , \qquad ( 1 )$$

As shown in FIG. 8, an operation generation task and a third description generation task are sequentially performed based on a prompt information Prompt1 by using a text analysis large model Reasoner to generate three second description information with semantic granularities 1 to 3, as shown in step 2: “Semantic granularity 1: a woman wearing a black shirt is cooking using a stove, with a black dog sitting next to her. Semantic granularity 2: a woman wearing a black shirt is cooking using a stove in a kitchen, with a black dog sitting next to her. Semantic granularity 3: a woman wearing a black shirt is cooking using a stove in a kitchen, with a black dog sitting next to a gray refrigerator”. As shown in FIG. 8, the operation prompt information generated by the operation generation task may be that in step 1: “1. Addition: add a woman wearing a black shirt. 2. Addition: the woman is cooking. 3. Removal: remove the brown dog. 4. Retention: retain the black dog”.

A process of generating at least one second description information using the text analysis large model Reasoner may be expressed by Equation (2).

$$O , {T}_{CE} , {T}_{ED} , {T}_{CS} = Reasoner ( , {T}_{r} , Prompt 1 ) , \qquad ( 2 )$$

where [symbol] represents the second text information,

$$O = {\{ {o}_{i} \}}_{i = 1}^{M}$$

represents a set of M operations Oᵢ, and T_{CE}, T_{ED}, T_{CS} represent three second description information with semantic granularities CE, ED and CS, respectively.

The second description information T_{CE}, T_{ED}, T_{CS} may be vectorized using the vision-language model (VLM), and the obtained text embedding features may be represented by v_{CE}, v_{ED}, v_{CS}, where v_{CE}, v_{ED}, v_{CS}∈ [symbol] ^{1×d}, d represents a vector length, and v_{CE}, v_{ED}, v_{CS}=VLM(T_{CE}, T_{ED}, T_{CS}).

In addition, on another branch, for the M candidate images in the search image library, such as image 1, image 2 . . . image M, the third description information for each candidate image may be pre-generated using the description generation large model Captioner. For example, given a text input “please describe this picture” and a search image library [symbol] , the description generation large model Captioner may output the third description information T₁, . . . T_{N}=Captioner( [symbol] ) for the corresponding image. After that, the third description information for each candidate image is vectorized using VLM to obtain a text embedding feature (text vector), and each candidate image is vectorized to obtain an image embedding feature (image vector). The conversion process may be expressed by Equation (3) and Equation (4)

$${V}_{T} = {v}_{t 1} , {v}_{t 2} , … , {v}_{tN} = VLM ( {T}_{1} , {T}_{2} , … , {T}_{N} ) , \qquad ( 3 )$$

$${V}_{l} = {v}_{i 1} , {v}_{i 2} , … , {v}_{{i}_{N}} = VLM ( {I}_{1} , {I}_{2} , … , {I}_{N} ) , \qquad ( 4 )$$

where vₜ₁, vₜ₂, . . . , v_{tN}∈ [symbol] ^{1×d} represents text vectors having a length d corresponding to each third description information, vᵢ₁, vᵢ₂, . . . , vᵢ_{_{N}}∈ [symbol] ^{N×d} represents image vectors having a length d corresponding to each candidate image, V_{T}∈ [symbol] ^{N×d} represents a matrix form of text vectors of all of the third description information, and V_{I}∈ [symbol] ^{N×d} represents a matrix form of all of the image vectors.

After the at least one second description information is generated using the text analysis large model Reasoner, a similarity between the text embedding feature of the second description information and the image embedding feature of the candidate image and a similarity between the text embedding feature of the second description information and the text embedding feature of the third description information for the candidate image may be calculated to obtain the third comprehensive similarity of each candidate image. The process may be expressed by Equation (5).

$$s = \frac{1}{3} {\sum }_{g ∈ \{ CE , ED , CS \}} ( τ \cdot sim ( {v}_{g} , {V}_{T} ) + ( 1 - τ ) \cdot sim ( {v}_{g} , {V}_{l} ) ) , \qquad ( 5 )$$

where S represents a vector form of the third comprehensive similarities of the plurality of candidate images, and s∈ [symbol] ^{1×d}, sim(⋅,⋅) represents a cosine similarity function, v_{g} represents an abbreviation of the text embedding feature at three semantic granularities, and τ is used to adjust weights of sim(v_{g}, V_{T}) and sim(v_{g}, V_{I}).

A process of determining at least one target image according to the third comprehensive similarity may be expressed by Equation (6).

$$\{ {C}_{1} , {C}_{2} , … , {C}_{N} \} = {argsort}_{↓} ( s ) , \qquad ( 6 )$$

where C₁, C₂, . . . , C_{N} represents an image search sequence obtained by sorting N candidate images

$${\{ {I}_{i} \}}_{i = 1}^{N}$$

in a descending order.

In an embodiment, C₁ may be selected as a final target image for output.

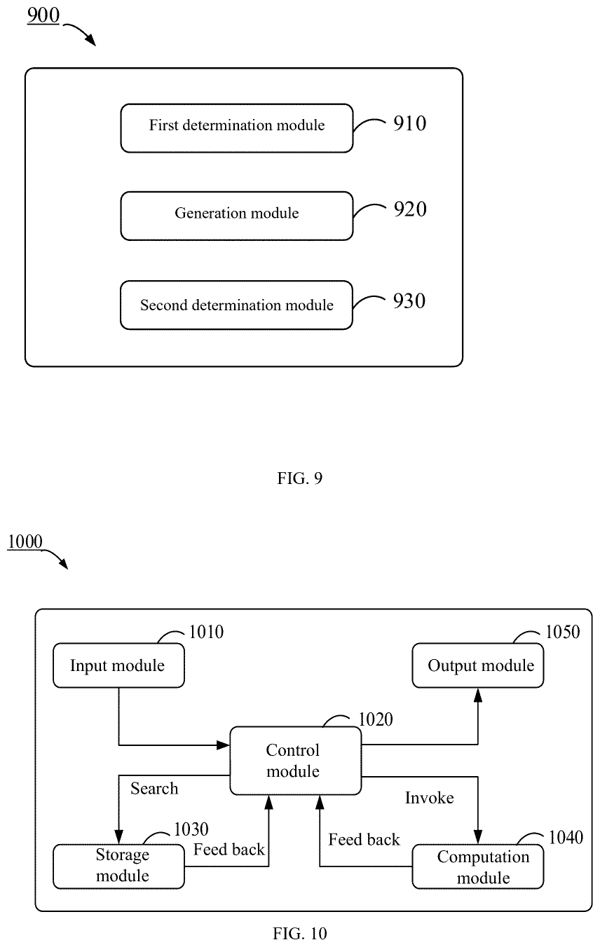

FIG. 9 schematically shows a block diagram of an image search apparatus according to an embodiment of the present disclosure.

As illustrated in FIG. 9, an image search apparatus 900 includes a first determination module 910, a generation module 920, and a second determination module 930.

The first determination module 910 is used to determine a multimodal search information according to an input information for image search, where the input information includes a first text information and/or a first reference image, and the search information includes a second text information and a second reference image.

The generation module 920 is used to perform, by using a text analysis large model, a text analysis on the second text information and a first description information describing the second reference image to generate at least one second description information.

The second determination module 930 is used to determine at least one target image according to the at least one second description information, where each of the at least one target image is determined according to the at least one second description information.

According to embodiments of the present disclosure, the first determination module 910 includes: a first determination sub-module used to determine the first text information as the second text information and acquire the second reference image when the input information includes the first text information, where the second reference image includes a blank reference image; a second determination sub-module used to determine the first reference image as the second reference image and acquire the second text information when the input information includes the first reference image, where the second text information includes a blank text information; and a third determination sub-module used to determine the first text information and the first reference image respectively as the second text information and the second reference image when the input information includes the first text information and the first reference image.

According to embodiments of the present disclosure, the image search apparatus 900 further includes: a third determination module used to determine an indicated image library as a search image library to determine the target image from the search image library when the input information includes the indicated image library; and a fourth determination module used to determine a reference image library as the search image library when the input information does not include the indicated image library.

According to embodiments of the present disclosure, the input information is obtained by: determining the first text information and/or the first reference image based on an input text and an input image in at least one round of dialogue; and/or determining the first reference image and/or the first text information based on at least one output image and/or the input text in at least one round of dialogue, where the output image is the target image determined and output according to the input information prior to the output image.

According to embodiments of the present disclosure, the text analysis large model is used to perform a first description generation task, and the generation module 920 includes: a first generation sub-module used to perform the first description generation task using the text analysis large model, so as to perform a semantic analysis on the second text information and the first description information to generate the second description information with a plurality of semantic granularities, where the semantic granularities are related to the number and/or attributes of elements in the second description information, and the elements are extracted from the second text information and/or the first description information.

According to embodiments of the present disclosure, the first generation sub-module includes: an acquisition unit used to acquire a prompt information, where the prompt information includes the plurality of semantic granularities to be generated and an explanation information for each semantic granularity; and a first generation unit used to perform the first description generation task using the text analysis large model, so as to perform a semantic analysis on the second text information and the first description information based on each semantic granularity to generate at least one second description information at each semantic granularity.

According to embodiments of the present disclosure, the text analysis large model is used to sequentially perform an operation generation task and a second description generation task, and the generation module 920 includes: a second generation sub-module used to perform the operation generation task using the text analysis large model to generate an operation prompt information according to a difference between the first description information and the second text information, where the operation prompt information includes at least one operation of at least one operation type; and a third generation sub-module used to perform the second description generation task using the text analysis large model to generate the at least one second description information according to the operation prompt information and the first description information.

According to embodiments of the present disclosure, the operation type of the at least one operation in the operation prompt information is an addition type when the second reference image is the blank reference image.

According to embodiments of the present disclosure, the text analysis large model is used to sequentially perform an operation generation task and a third description generation task, and the generation module 920 includes: a fourth generation sub-module used to perform the operation generation task using the text analysis large model to generate an operation prompt information according to a difference between the first description information and the second text information; and a fifth generation sub-module used to perform the third description generation task using the text analysis large model to generate the second description information with a plurality of semantic granularities according to the operation prompt information and the first description information.

According to embodiments of the present disclosure, the fourth generation sub-module includes: a second generation unit used to extract at least one operation from the second text information and determine the operation type according to the difference between the first description information and the second text information; or a third generation unit used to extract at least one initial operation from the second text information and determine the operation type according to the difference between the first description information and the second text information; and rewrite the initial operation using the first description information to obtain the operation.

According to embodiments of the present disclosure, the second determination module 930 includes: a fourth determination sub-module used to determine a similarity between the second description information and a third description information describing a candidate image, where the search image library includes a plurality of candidate images; a fifth determination sub-module used to determine a first comprehensive similarity for each candidate image according to the similarity with each second description information; and a sixth determination sub-module used to determine the at least one target image from the plurality of candidate images according to the first comprehensive similarity.

According to embodiments of the present disclosure, the second determination module 930 includes: an acquisition sub-module used to acquire an image embedding feature of each candidate image in the search image library; a seventh determination sub-module used to determine a second comprehensive similarity for each candidate image according to a similarity between the image embedding feature and a text embedding feature of each second description information; and an eighth determination sub-module used to determine the at least one target image from the plurality of candidate images according to the second comprehensive similarity.

According to embodiments of the present disclosure, the second determination module 930 further includes: a ninth determination sub-module used to determine a third comprehensive similarity for each candidate image according to a similarity between the third description information and each second description information and a similarity between an image embedding feature of the candidate image and a text embedding feature of each second description information; and a tenth determination sub-module used to determine the at least one target image from the plurality of candidate images according to the third comprehensive similarity.

According to embodiments of the present disclosure, the image search apparatus 900 further includes: a first conversion module used to convert the second reference image into the first description information using a description generation large model; and a second conversion module used to convert the candidate image into the third description information using the description generation large model.

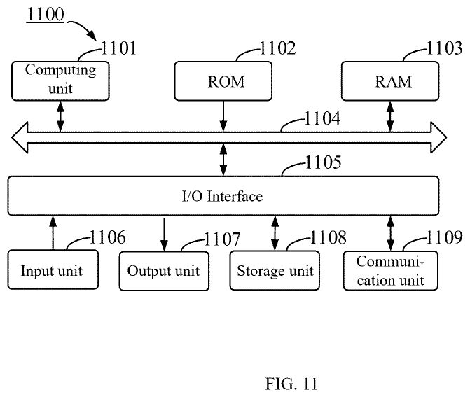

FIG. 10 schematically shows a structural block diagram of an intelligent agent of artificial intelligence according to embodiments of the present disclosure.

In embodiments of the present disclosure, inspired by the von Neumann architecture in modern computer theory, as shown in FIG. 10, an AI agent 1000 may include five core modules, namely an input module 1010, a control module 1020, a storage module 1030, a computation module 1040, and an output module 1050.

The input module 1010 is used to receive or sense information such as queries, requests, instructions, signals or data from the outside world (e.g., users or external environments) and convert the information into a format that the AI agent 1000 may understand and process. The input module 1010 is a primary link for the AI agent 1000 to interact with the outside world, enabling the AI agent 1000 to efficiently and accurately acquire necessary “sensory” information and make a response to the information.

In an example, the input module 1010 may receive the input information, the first text information and the first reference image mentioned above.

In an example, the control module 1020 is a core support for the AI agent 1000's ability to handle complex tasks. The control module 1020 may perform the image search method described above.

In an example, during operation, the control module 1020 may continuously interact with the storage module 1030, the computation module 1040 and/or the output module 1050. However, it should be noted that in embodiments of the present disclosure, the control module 1020 acts as a sole initiator to initiate communication with the storage module 1030, the computation module 1040 and/or the output module 1050, while no communication coupling is provided between the storage module 1030, the computation module 1040 and the output module 1050.

In an example, the performance of the control module 1020 may be closely related to the large model on which the AI agent 1000 is based. In order to fully leverage the capabilities of the large model, an internal structure of the control module 1020 may be designed to be highly configurable and scalable, so as to handle various types of tasks and requirements in real-world scenarios, etc.

The storage module 1030 may be used to remember information such as historical dialogues and event streams. The prompt information, the third description information for the candidate image, etc. mentioned above may be included in the storage module 1030.

The computation module 1040 may be regarded as a predefined tool library. Controls used for text embedding and image embedding mentioned above may be included in the computation module 1040.

In an example, the output module 1050 may output the at least one target image mentioned above.

The AI agent 1000 according to embodiments of the present disclosure may simply and effectively enhance the level of intelligence and improve flexibility and versatility.

According to embodiments of the present disclosure, the present disclosure further provides an electronic device, a readable storage medium, and a computer program product.

According to embodiments of the present disclosure, an electronic device is provided, including: at least one processor; and a memory communicatively connected to the at least one processor. The memory stores instructions executable by the at least one processor, and the instructions are used to, when executed by the at least one processor, cause the at least one processor to implement the method described above.

According to embodiments of the present disclosure, a non-transitory computer-readable storage medium having computer instructions therein is provided, and the computer instructions are used to cause a computer to implement the methods described above.

According to embodiments of the present disclosure, a computer program product containing a computer program is provided, and the computer program is used to, when executed by a processor, cause the processor to implement the method described above

FIG. 11 schematically shows a block diagram of an electronic device 1100 suitable for implementing the image search method according to embodiments of the present disclosure. The electronic device is intended to represent various forms of digital computers, such as a laptop computer, a desktop computer, a workstation, a personal digital assistant, a server, a blade server, a mainframe computer, and other suitable computers. The electronic device may further represent various forms of mobile devices, such as a personal digital assistant, a cellular phone, a smart phone, a wearable device, and other similar computing devices. The components as illustrated herein, and connections, relationships, and functions thereof are merely examples, and are not intended to limit the implementation of the present disclosure described and/or required herein.

As shown in FIG. 11, the electronic device 1100 includes a computing unit 1101 which may perform various appropriate actions and processes according to a computer program stored in a read only memory (ROM) 1102 or a computer program loaded from a storage unit 1108 into a random access memory (RAM) 1103. In the RAM 1103, various programs and data necessary for an operation of the electronic device 1100 may also be stored. The computing unit 1101, the ROM 1102 and the RAM 1103 are connected to each other through a bus 1104. An input/output (I/O) interface 1105 is also connected to the bus 1104.

A plurality of components in the electronic device 1100 are connected to the I/O interface 1105, including: an input unit 1106, such as a keyboard, or a mouse; an output unit 1107, such as displays or speakers of various types; a storage unit 1108, such as a disk, or an optical disc; and a communication unit 1109, such as a network card, a modem, or a wireless communication transceiver. The communication unit 1109 allows the electronic device 1100 to exchange information/data with other devices through a computer network such as Internet and/or various telecommunication networks.

The computing unit 1101 may be various general-purpose and/or dedicated processing assemblies having processing and computing capabilities. Some examples of the computing units 1101 include, but are not limited to, a central processing unit (CPU), a graphics processing unit (GPU), various dedicated artificial intelligence (AI) computing chips, various computing units that run machine learning model algorithms, a digital signal processing processor (DSP), and any suitable processor, controller, microcontroller, etc. The computing unit 1101 executes various methods and processes described above, such as the image search method. For example, in some embodiments, the image search method may be implemented as a computer software program which is tangibly embodied in a machine-readable medium, such as the storage unit 1108. In some embodiments, the computer program may be partially or entirely loaded and/or installed in the electronic device 1100 via the ROM 1102 and/or the communication unit 1109. The computer program, when loaded in the RAM 1103 and executed by the computing unit 1101, may execute one or more steps in the image search method described above. Alternatively, in other embodiments, the computing unit 1101 may be used to perform the image search method by any other suitable means (e.g., by means of firmware).

Various embodiments of the systems and technologies described herein may be implemented in a digital electronic circuit system, an integrated circuit system, a field programmable gate array (FPGA), an application specific integrated circuit (ASIC), an application specific standard product (ASSP), a system on chip (SOC), a complex programmable logic device (CPLD), a computer hardware, firmware, software, and/or combinations thereof. These various embodiments may be implemented by one or more computer programs executable and/or interpretable on a programmable system including at least one programmable processor. The programmable processor may be a dedicated or general-purpose programmable processor, which may receive data and instructions from a storage system, at least one input device and at least one output device, and may transmit the data and instructions to the storage system, the at least one input device, and the at least one output device.

Program codes for implementing the image search method of the present disclosure may be written in one programming language or any combination of more programming languages. These program codes may be provided to a processor or controller of a general-purpose computer, a dedicated computer or other programmable data processing apparatus, such that the program codes, when executed by the processor or controller, cause the functions/operations specified in the flowcharts and/or block diagrams to be implemented. The program codes may be executed entirely on a machine, partially on a machine, partially on a machine and partially on a remote machine as a stand-alone software package or entirely on a remote machine or server.

In the context of the present disclosure, a machine-readable medium may be a tangible medium that may contain or store a program for use by or in connection with an instruction execution system, an apparatus or a device. The machine-readable medium may be a machine-readable signal medium or a machine-readable storage medium. The machine-readable medium may include, but is not limited to, an electronic, magnetic, optical, electromagnetic, infrared, or semiconductor system, apparatus or device, or any suitable combination of the above. More specific examples of the machine-readable storage medium may include an electrical connection based on one or more wires, a portable computer disk, a hard disk, a random access memory (RAM), a read only memory (ROM), an erasable programmable read only memory (EPROM or a flash memory), an optical fiber, a compact disk read only memory (CD-ROM), an optical storage device, a magnetic storage device, or any suitable combination of the above.

In order to provide interaction with the user, the systems and technologies described here may be implemented on a computer including a display device (for example, a CRT (cathode ray tube) or LCD (liquid crystal display) monitor) for displaying information to the user, and a keyboard and a pointing device (for example, a mouse or a trackball) through which the user may provide the input to the computer. Other types of devices may also be used to provide interaction with the user. For example, a feedback provided to the user may be any form of sensory feedback (for example, visual feedback, auditory feedback, or tactile feedback), and the input from the user may be received in any form (including acoustic input, voice input or tactile input).

The systems and technologies described herein may be implemented in a computing system including back-end components (for example, a data server), or a computing system including middleware components (for example, an application server), or a computing system including front-end components (for example, a user computer having a graphical user interface or web browser through which the user may interact with the implementation of the system and technology described herein), or a computing system including any combination of such back-end components, middleware components or front-end components. The components of the system may be connected to each other by digital data communication (for example, a communication network) in any form or through any medium. Examples of the communication network include a local area network (LAN), a wide area network (WAN), and the Internet.

The computer system may include a client and a server. The client and the server are generally far away from each other and usually interact through a communication network. A relationship between the client and the server is generated through computer programs running on the corresponding computers and having a client-server relationship with each other. The server may be a cloud server, a server of a distributed system, or a server combined with a block-chain.

It should be understood that steps of the processes illustrated above may be reordered, added or deleted in various manners. For example, the steps described in the present disclosure may be performed in parallel, sequentially, or in a different order, as long as a desired result of the technical solution of the present disclosure may be achieved. This is not limited in the present disclosure.

The above-mentioned specific embodiments do not constitute a limitation on the scope of protection of the present disclosure. Those skilled in the art should understand that various modifications, combinations, sub-combinations and substitutions may be made according to design requirements and other factors. Any modifications, equivalent replacements and improvements made within the spirit and principles of the present disclosure shall be contained in the scope of protection of the present disclosure.

What is claimed is:

1. An image search method, comprising:
determining a multimodal search information according to an input information for image search, wherein the input information comprises a first text information and/or a first reference image, and the search information comprises a second text information and a second reference image;
performing, by using a text analysis large model, a text analysis on the second text information and a first description information describing the second reference image to generate at least one second description information; and
determining at least one target image according to the at least one second description information, wherein each of the at least one target image is determined according to the at least one second description information.

2. The method according to claim 1, wherein the determining a multimodal search information according to an input information for image search comprises:
determining the first text information as the second text information and acquiring the second reference image when the input information comprises the first text information, wherein the second reference image comprises a blank reference image;
determining the first reference image as the second reference image and acquiring the second text information when the input information comprises the first reference image, wherein the second text information comprises a blank text information; and
determining the first text information and the first reference image respectively as the second text information and the second reference image when the input information comprises the first text information and the first reference image.

3. The method according to claim 1, further comprising:
determining an indicated image library as a search image library to determine the target image from the search image library when the input information comprises the indicated image library;
determining a reference image library as the search image library when the input information does not comprise the indicated image library.

4. The method according to claim 1, wherein the input information is obtained by at least one of:
determining the first text information and/or the first reference image based on an input text and an input image in at least one round of dialogue; and
determining the first reference image and/or the first text information based on at least one output image and/or the input text in at least one round of dialogue, wherein the output image is the target image determined and output according to the input information prior to the output image.

5. The method according to claim 1, wherein the text analysis large model is configured to perform a first description generation task, and the performing, by using a text analysis large model, a text analysis on the second text information and a first description information describing the second reference image to generate at least one second description information comprises:
performing the first description generation task using the text analysis large model, so as to perform a semantic analysis on the second text information and the first description information to generate the second description information with a plurality of semantic granularities, wherein the semantic granularities are related to the number and/or attributes of elements in the second description information, and the elements are extracted from the second text information and/or the first description information.

6. The method according to claim 5, wherein the performing the first description generation task using the text analysis large model so as to perform a semantic analysis on the second text information and the first description information to generate the second description information with a plurality of semantic granularities comprises:
acquiring a prompt information, wherein the prompt information comprises the plurality of semantic granularities to be generated and an explanation information for each semantic granularity; and
performing the first description generation task using the text analysis large model, so as to perform a semantic analysis on the second text information and the first description information based on each semantic granularity to generate the second description information at each semantic granularity.

7. The method according to claim 1, wherein the text analysis large model is configured to sequentially perform an operation generation task and a second description generation task, and the performing, by using a text analysis large model, a text analysis on the second text information and a first description information describing the second reference image to generate at least one second description information comprises:
performing the operation generation task using the text analysis large model to generate an operation prompt information according to a difference between the first description information and the second text information, wherein the operation prompt information comprises at least one operation of at least one operation type; and
performing the second description generation task using the text analysis large model to generate the at least one second description information according to the operation prompt information and the first description information.

8. The method according to claim 7, wherein the operation type of the at least one operation in the operation prompt information is an addition type when the second reference image is the blank reference image.

9. The method according to claim 1, wherein the text analysis large model is configured to sequentially perform an operation generation task and a third description generation task, and the performing, by using a text analysis large model, a text analysis on the second text information and a first description information describing the second reference image to generate at least one second description information comprises:
performing the operation generation task using the text analysis large model to generate an operation prompt information according to a difference between the first description information and the second text information; and
performing the third description generation task using the text analysis large model to generate the second description information with a plurality of semantic granularities according to the operation prompt information and the first description information.

10. The method according to claim 7, wherein the generating an operation prompt information according to a difference between the first description information and the second text information comprises:
extracting at least one operation from the second text information and determining the operation type according to the difference between the first description information and the second text information; or
extracting at least one initial operation from the second text information and determining the operation type according to the difference between the first description information and the second text information; and rewriting the initial operation using the first description information to obtain the operation.

11. The method according to claim 1, wherein the determining at least one target image according to the at least one second description information comprises:
determining a similarity between the second description information and a third description information describing a candidate image, wherein the search image library comprises a plurality of candidate images;
determining a first comprehensive similarity for each candidate image according to the similarity with each second description information; and
determining the at least one target image from the plurality of candidate images according to the first comprehensive similarity.

12. The method according to claim 1, wherein the determining at least one target image according to the at least one second description information comprises:
acquiring an image embedding feature of each candidate image in the search image library;
determining a second comprehensive similarity for each candidate image according to a similarity between the image embedding feature and a text embedding feature of each second description information; and
determining the at least one target image from the plurality of candidate images according to the second comprehensive similarity.

13. The method according to claim 11, further comprising:
determining a third comprehensive similarity for each candidate image according to a similarity between the third description information and each second description information and a similarity between an image embedding feature of the candidate image and a text embedding feature of each second description information; and
determining the at least one target image from the plurality of candidate images according to the third comprehensive similarity.

14. The method according to claim 1, further comprising:
converting the second reference image into the first description information using a description generation large model; and
converting the candidate image into the third description information using the description generation large model.

15. An intelligent agent, configured to perform the method of claim 1.

16. An electronic device, comprising:
at least one processor; and
a memory communicatively connected to the at least one processor, wherein the memory stores instructions executable by the at least one processor, and the instructions are configured to, when executed by the at least one processor, cause the at least one processor to at least:
determine a multimodal search information according to an input information for image search, wherein the input information comprises a first text information and/or a first reference image, and the search information comprises a second text information and a second reference image;
perform, by using a text analysis large model, a text analysis on the second text information and a first description information describing the second reference image to generate at least one second description information; and
determine at least one target image according to the at least one second description information, wherein each of the at least one target image is determined according to the at least one second description information.

17. The electronic device according to claim 16, wherein the at least one processor is further configured to:
determine the first text information as the second text information and acquiring the second reference image when the input information comprises the first text information, wherein the second reference image comprises a blank reference image;
determine the first reference image as the second reference image and acquire the second text information when the input information comprises the first reference image, wherein the second text information comprises a blank text information; and
determine the first text information and the first reference image respectively as the second text information and the second reference image when the input information comprises the first text information and the first reference image.

18. The electronic device according to claim 16, the at least one processor is further configured to:
determine an indicated image library as a search image library to determine the target image from the search image library when the input information comprises the indicated image library;
determine a reference image library as the search image library when the input information does not comprise the indicated image library.

19. The electronic device according to claim 16, wherein the input information is obtained by at least one of:
determining the first text information and/or the first reference image based on an input text and an input image in at least one round of dialogue; and
determining the first reference image and/or the first text information based on at least one output image and/or the input text in at least one round of dialogue, wherein the output image is the target image determined and output according to the input information prior to the output image.

20. A non-transitory computer-readable storage medium having computer instructions therein, wherein the computer instructions are configured to cause a computer to at least:
determine a multimodal search information according to an input information for image search, wherein the input information comprises a first text information and/or a first reference image, and the search information comprises a second text information and a second reference image;
perform, by using a text analysis large model, a text analysis on the second text information and a first description information describing the second reference image to generate at least one second description information; and
determine at least one target image according to the at least one second description information, wherein each of the at least one target image is determined according to the at least one second description information.
